(19) United States
(12) Patent Application Publication
(10) Pub. No.: US 2014/0053448 A1
(43) Pub. Date: Feb. 27, 2014

(54) Fish-Ball Fish Attractor

(71) Applicant: Scott G. Kapolnek, Genoa City, WI (US)

(72) Inventor: Scott G. Kapolnek, Genoa City, WI (US)

(21) Appl. No.: 13/594,793

(22) Filed: Aug. 25, 2012

(51) Int. Cl. A01K 97/02; A01K 99/00; A01K 97/05

(52) U.S. Cl. 43/4.5; 43/44.99

(57) ABSTRACT

A fish attractor that can be a transparent or translucent hollow ball, or other shape with a plurality of holes in its surface to allow water to flow in and out. A removable lid or other access allows putting bait into the device. The device, which is filled with water, acts as a tank for the bait to swim around in or otherwise be displayed. The device can then be suspended from a line or float, or otherwise inserted under the surface of the water. When a larger fish spots the device, it sees only the bait. If it attacks the device or even approaches it, the bait fish inside are protected, but become highly agitated. This can cause the larger fish to go into a feeding frenzy trying to get at the bait which in turn attracts even more fish.

### BACKGROUND

1. Field of the Invention

The present invention relates generally to the field of fishing equipment and more particularly to a fish-ball fish attractor.

2. Description of the Prior Art

Fishermen have used numerous ways to attract fish to their boats or fishing vicinity. The prior art contains numerous shinny or sparkling lures, lures that twist and turn, lures that make sounds when pulled through the water, and lures that release scents into the water. Fishermen have also been known to “chum” or throw live or dead bait into the water in the hopes of attracting larger fish. This practice is illegal in some fishing localities.

All fish attractors and bait must accomplish one task—they must make the fish think it has detected pray so that it decides to feed. Fish generally have poor eyesight and typically recognize their natural pray by size and particularly by motion. Pray in the correct size and color range that moves in convincing manner can act as bait. Also, when one larger fish attacks into a group of smaller fish, many of the smaller fish move very quickly, and an entire school of fish may become very agitated. This agitated motion, especially in a school or group of pray fish can attract other nearby fish into the attack and can lead to what has been called a feeding frenzy.

It would be advantageous to have a fish attractor that is easy to construct and use, that displays pray fish or bait in a realistic configuration and allows the bait fish to react and become agitated.

### SUMMARY OF THE INVENTION

The present invention relates to a fish attractor that can be a transparent or translucent ball, or other shape, with numerous small holes to allow water to freely flow in and out. The ball or other shape can be colored or not colored, and can be fluorescent or have any other means of presentation. A removable lid allows a fisherman to put live bait fish into the ball, or the device can swing open. The ball, which is typically completely filled with water, acts as a fish tank for the bait to swim around in or for artificial bait to be presented. The ball can then be suspended from a line or float, or otherwise inserted under the surface of the water in a fishing area. When a larger fish spots the ball, it sees only the bait. If it attacks the ball or even approaches it, the bait fish inside are protected, but become highly agitated. This can cause the larger fish to go into a feeding frenzy trying to get at the bait fish which in turn attracts even more fish.

A separate line and lure or line and hook with bait can be placed into the water near the ball. As the frenzy attracts more fish, many will begin to take the real lures and be caught This process can continue as long as there are larger fish in the area without sacrificing the bait fish in the ball. In one embodiment of the invention, a light can be placed in the ball for night fishing. The bait-ball can be optionally loaded with bait fish at a remote location and carried to and from the fishing location in a bait bucket filled with water.

### DESCRIPTION OF THE FIGURES

Attention is now directed at several drawings that illustrate features of the present invention:

FIG. 1 shows an embodiment of the bait ball of the present invention.

FIG. 2 shows the embodiment of FIG. 1 suspended on a line and float.

FIG. 3 shows a ball with a line passing through and weight forming a shallow water anchor

FIG. 4 shows the use of a ball with a bait bucket.

FIG. 5 shows a ball with a light for night fishing.

FIG. 6 shows several balls used to separate bait in a live well.

FIG. 7 shows a ball with a stabilizing weight for use in moving water.

FIG. 8 shows use of the a ball with a bait dredge. An optional camera is also shown mounted to the bottom of the ball.

FIG. 9 shows a cylindrical embodiment of the present invention.

FIG. 10 shows a swing-open embodiment of the present invention.

Several drawings and illustrations have been presented to aid in understanding the present invention. The scope of the present invention is not limited to what is shown in the figures.

### DETAILED DESCRIPTION

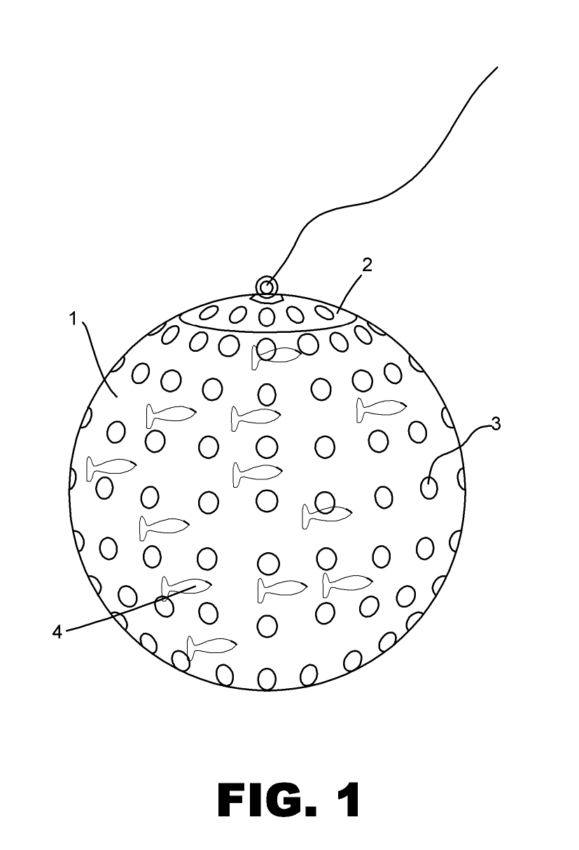

The present invention relates to a bait ball fish attractor similar to that shown in FIG. 1. A clear (transparent) or translucent ball or other shape 1 can be made from plastic or other material and be supplied with typically many small holes 3 in its surface to allow water to enter and leave keeping up good water circulation when the device is submerged. This serves to keep live bait alive. While the preferred shape is substantially spherical, any shape is within the scope of the present invention. The device can be plain or colored. Various colors may be used to advantage to attract particular kinds of fish.

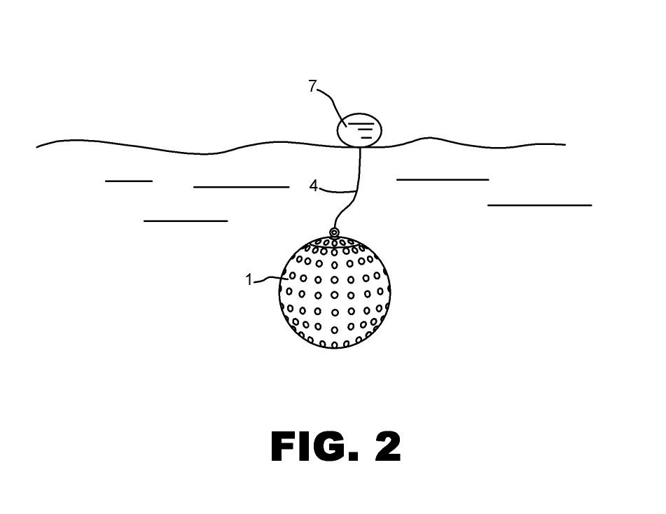

A group of bait fish 4 or artificial bait can be placed in the device through a lid 2. By bait, I mean any type of lure or live fish that can attract other fish. Any type of bait is within the scope of the present invention. The lid can be a spring-loaded, pop-up lid on a hinge, a screw-in lid with threads, or any other type of removable lid. The ball acts as a natural threatened ball of bait. This acts as an attractant to bigger fish with no danger of losing the bait. The ball 1 can be suspended on a line 4 or otherwise held below the surface in the fishing location. FIG. 2 shows a bait ball suspended by a line from an attachment hook or ring 15.

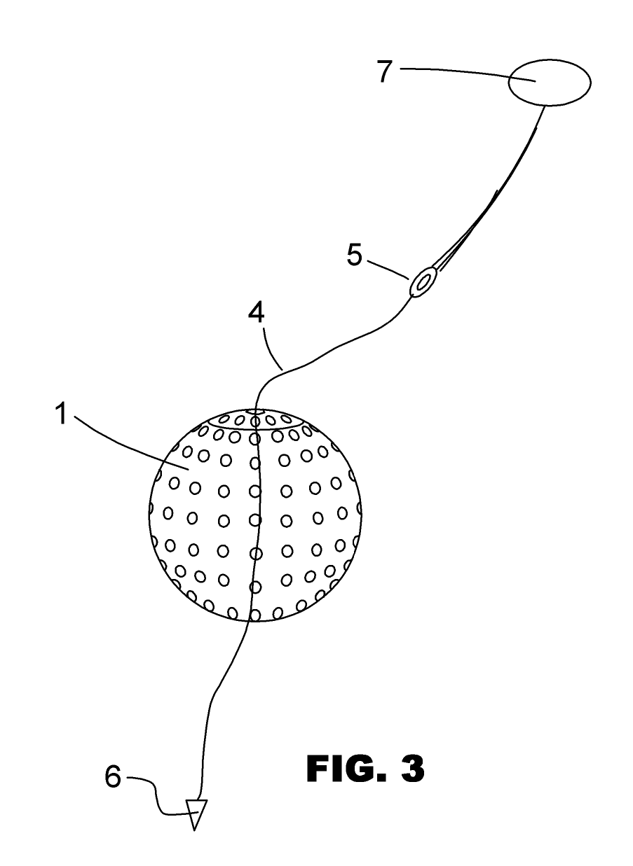

FIG. 3 shows an alternative way of securing the ball. A line 4 can be passed through the ball 1 and terminated in a weight 6. A float 7 keeps the ball near the surface, while a stopper 5 can be used to set the depth of the ball 1. This enables the device to be used in shallow water as a shallow water anchor. The device can be allowed to drift further away from the boat, pier, sea wall, beach or wherever the fisherman may be fishing from. Typically, the ball is kept just under the surface, but some situations may require it to be set deeper.

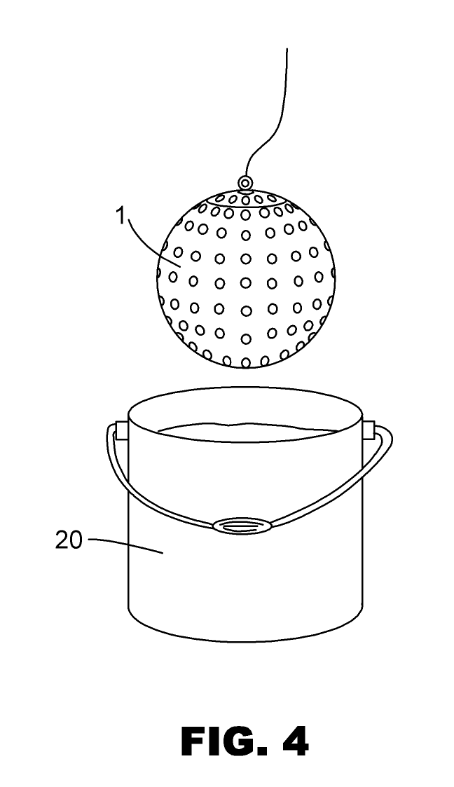

FIG. 4 shows a bait ball 1 being used with a bait or go-bucket 7. This enables the fisherman to transport the bait to any location be it by car or boat to a favorite fishing location. It also allows pulling anchor and moving to a different location without losing or risking the bait. The bucket 7 simply contains a level of water so that the bait ball 1 can be submerged in the bucket.

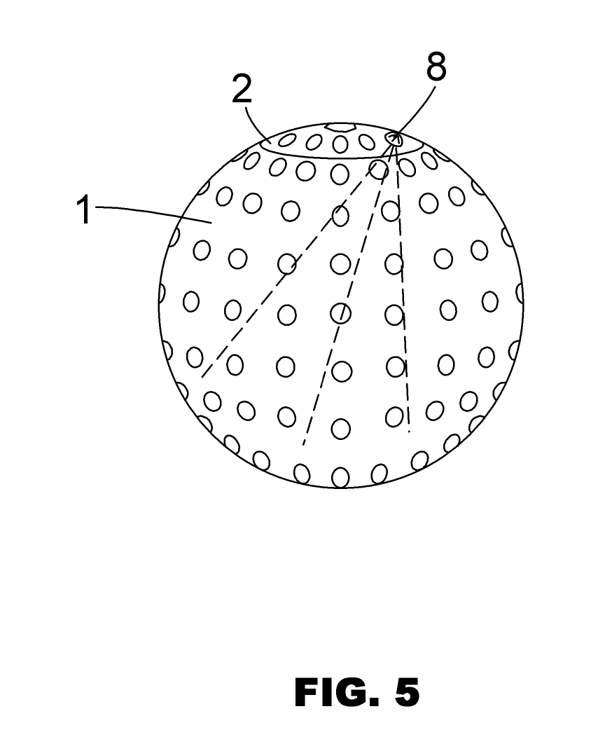

FIG. 5 shows a bait ball 1 with a waterproof light 8 mounted in the lid 2. This embodiment is particularly useful for night fishing. In this case, the invention not only attracts predatory fish, but also other small fish that act as additional attractants to larger fish. The light 8 is best placed so that it illuminates the bait in the ball. This way other larger fish can see them.

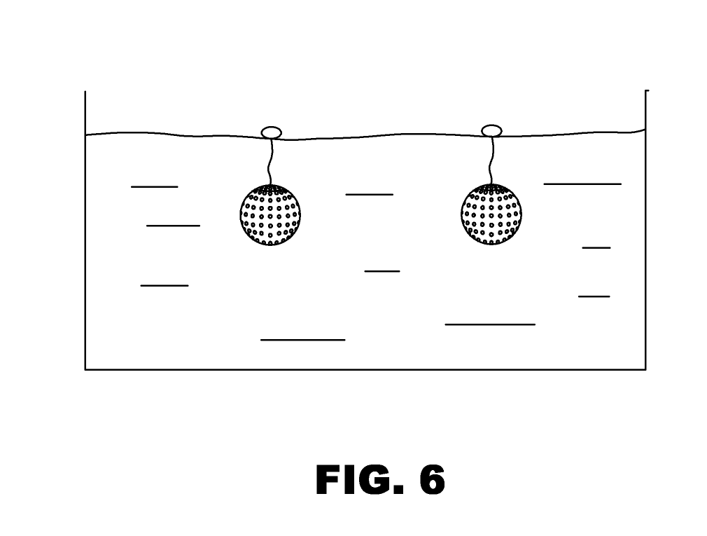

The bait ball can also be used as a bait well buddy as shown in FIG. 6. In this application, several bait balls (possibly of smaller sizes) can contain different types of bait and be submerged in a live well. Each bait ball can have an identifiable float (possibly of a unique color). In this application, there is no searching in the live well for particular bait. The fisherman can simply take pull out the float that identifies the desired bait when it is needed. Alternatively, different balls could be coded with different colors. The holes in the bait balls should allow adequate water circulation keeping the bait healthy but also separated by type in the live well.

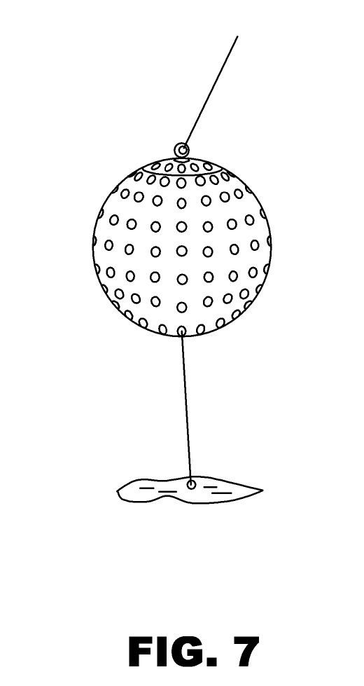

The present invention can be used with a stabilizing weight extended from the bottom as shown in FIG. 7. This allows the ball to be submerged in moving water such as in currents in the ocean, surf or in moving rivers. The more line the fisherman feeds out, the deeper the ball will go.

Different embodiments of the present invention can be used for ice fishing. Typically, the diameter of the ball must be small enough to fit through a standard fishing ice hole. In general, a separate hole can be cut for the bait ball with one or more fishing holes nearby.

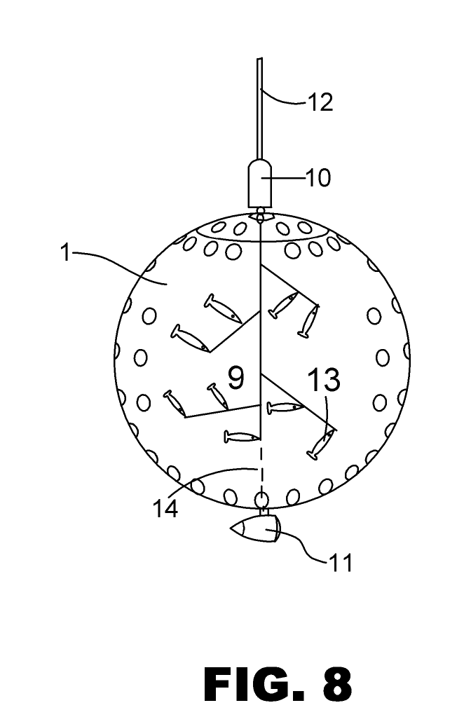

FIG. 8 shows a bait ball of the present invention being used with an interchangeable bait dredge. This bait dredge can optionally be a consumable or can be disposable. The bait dredge 9 is placed in the bait ball 1. A waterproof motor 10 can be connected to the surface with a power cable 12. The bait dredge 9 is a device that holds artificial bait 13 and causes them to rotate and otherwise move. The ball is used to attract fish just as with live bait. The artificial bait can be made to simply move smoothly like swimming fish, or other types of motion can be used such a stuttering. Any type of motion is within the scope of the present invention.

FIG. 8 also shows an optional camera 11 attached to the bottom of the ball. The cable 12 can be extended 14 down to the camera 11 to provide power and/or return video. The camera 11 can also be battery powered. While, the camera 11 is shown in this particular embodiment, it should be understood that a camera or a camera and light can be used with any embodiment of the present invention.

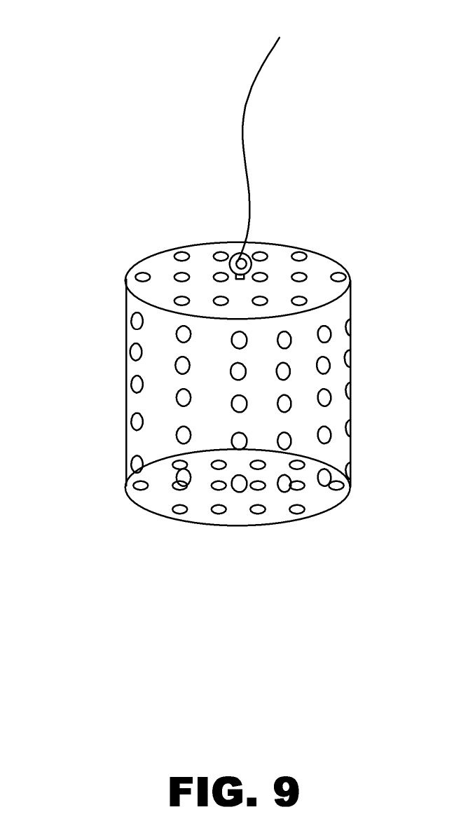

While the preferred shape is substantially spherical, the bait ball can be any shape, shell, hull or form including a box, a cylinder or any other shape. It must have a closed interior space to hold bait. FIG. 9 shows a cylindrical embodiment of the present invention.

As previously stated, the preferred material for the bait ball is clear plastic such as plastic sold under the names of Lucite™ or Plexiglass™. Any transparent or translucent material is within the scope of the present invention, and the device can be supplied in any color. The device may also be supplied with different sized holes for different sized bait.

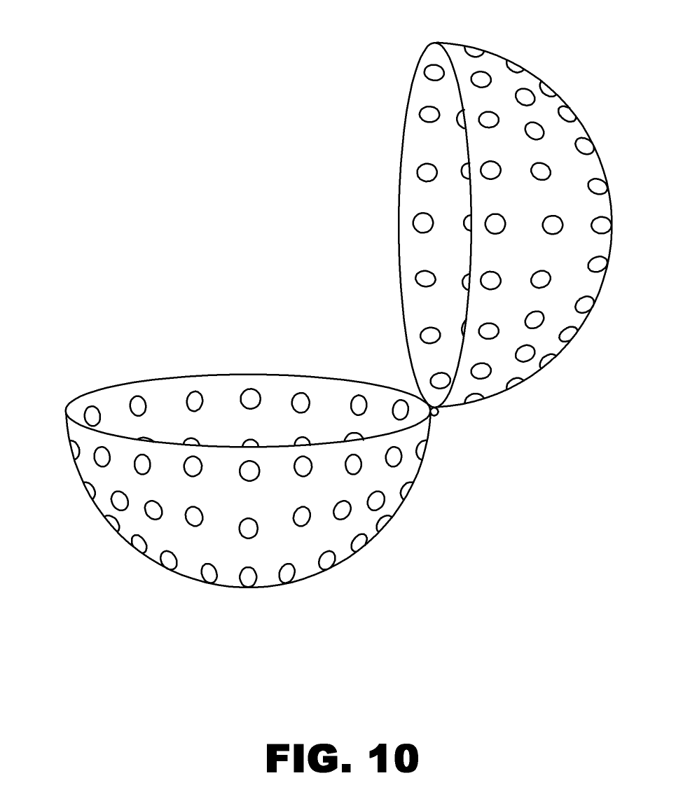

The present invention has an access or access port that allows placement of bait within. Typically, this is some type of lid. Any method of attaching the lid to the present invention is within the scope of the present invention. A spring lid that is easily opened or closed by the fisherman, but will not open by itself, if preferred. FIG. 10. shows an embodiment of the invention that swings open. While the split is shown a approximate the equator of the device in FIG. 10, it can be at any latitude.

Several descriptions and illustrations have been provided to aid in understanding the present invention. One with skill in the art will realize that numerous changes and variations may be made without departing from the spirit of the invention. Each of these changes and variations is within the scope of the present invention.

I claim:

1. A fish-attracting device comprising:
a transparent or translucent surface enclosing an internal cavity;
an access in said surface adapted to allow bait to be placed into said cavity;
said surface having a plurality of holes large enough to allow water to flow freely into and out of said cavity but small enough to prevent the bait from escaping.

2. The fish-attracting device of claim 1 further wherein said access is a lid located at the top of said device.

3. The fish-attracting device of claim 1 wherein said access is spring-loaded.

4. The fish-attracting device of claim 1 further comprising a light attached to said device.

5. The fish-attracting device of claim 1 further comprising a camera attached to said device.

6. The fish-attracting device of claim 1 wherein said surface substantially forms a sphere.

7. The fish-attracting device of claim 1 further comprising a weight attached to said device.

8. The fish-attracting device of claim 2 wherein said access is spring-loaded.

9. The fish-attracting device of claim 8 further comprising a light attached to said device.

10. The fish-attracting device of claim 9 further comprising a camera attached to said device.

11. A method of attracting fish comprising:
providing a device according to claim 1;
allowing bait to be placed in said device;
allowing said device to be suspended underwater in a fishing area.

12. An apparatus that allows presentation of bait underwater comprising:
a substantially spherical transparent or translucent container with an access, the access adapted to allow bait to be placed in the container;
a plurality of holes in the container that allow water to flow into and out of the container, the holes small enough to prevent the bait from escaping;
means for suspending said container underwater.

13. The apparatus of claim 12 further comprising a weight attached to the container.

14. The apparatus of claim 12 further comprising a light.

15. The apparatus of claim 12 further comprising a camera.

16. The apparatus of claim 12 wherein said means for suspending is a line.

17. The apparatus of claim 16 further comprising a float attached to said line.

18. A method of attracting fish comprising:
adapting a submergible transparent or translucent container with a closable port so that bait can be placed in said container;
placing a plurality of holes in said container, the holes allowing water to circulate through said container when submerged, each hole being small enough to prevent said bait from escaping;
adapting said container to be suspended underwater.

19. The method of claim 18, further comprising adapting said container so that a light may be attached to said container.

20. The method of claim 18 further comprising adapting said container so that a camera may be attached to said container.

21. The method of claim 18 further comprising adapting said container so that a weight may be attached to said container.
